(19) United States
(12) Patent Application Publication
(10) Pub. No.: US 2018/0035856 A1
(43) Pub. Date: Feb. 8, 2018

(54) SURFACE TEXTURE REMOVAL DEVICE

(71) Applicant: ANDRAE JOSEPH SMITH, MIDLAND, TX (US)

(72) Inventor: ANDRAE JOSEPH SMITH, MIDLAND, TX (US)

(21) Appl. No.: 15/227,195

(22) Filed: Aug. 3, 2016

(51) Int. Cl. A47L 7/00; A47L 9/32; B08B 1/00; A47L 11/40

(52) U.S. Cl. CPC A47L 7/009; A47L 11/4075; A47L 11/4013; A47L 11/4044; A47L 9/327; B08B 1/005

(57) ABSTRACT

A new and improved surface texture removal device that removes material from drywall, plaster, and flat surfaces. The device has a pivoting and/or articulating hose end that can be attached to a vacuum. The device can be held by a handle on the top that has a screw attachment. The device's primary purpose is to collect texture material that accumulates during scraping with the intent of removing the textures to a vacuum canister. The device's internal construction is made to channel texture to and to balance suction for an even removal of texture material. The device can also serve as a dust pan when laid flat upside down. A collection tray is secured to the trailing edge of the chamber. A hose coupler is secured to the back of the chamber. The hose coupler includes a pivot joint secured to the chamber in an angular orientation. The hose coupler has an open outer end for coupling with a standard vacuum hose.

### BACKGROUND OF THE INVENTION

### 1. Field of the Invention

The present invention relates to a new and improved surface texture removal device with an integrated vacuum system. More particularly, the present invention relates to a device which enables removal of surface texture materials by providing a vacuum apparatus mounted on an angle and length adjustable handle configured for quick, easy and safe operation.

### 2. Description of the Prior Art

The present invention relates to a wall and surface texture removal device with a collection tray and more particularly pertains to collecting materials from a wall or surface so as to minimize clean-up.

The removal of wall coverings, such as wall paper, paint, ceiling plaster, or texture, usually involves the use of some type of scraping device that is directed into the wall or other surface in a scraping motion so as to facilitate it's removal. The unfortunate result of this removal is that the wall paper, paint, plaster, or texture falls to the floor and needs to be collected and discarded. What is needed is a method of removing such materials while at the same time collecting the removed materials so the worker will not have to clean up after or during the process.

There is no mechanism provided for the safe and effective removal and containment of the material being removed from the wall or surface after the scraping procedure. It is assumed that the debris resulting from the wall covering removal process would be removed mechanically which would lead to possible production of free flying dust particles which could easily be inhaled during the process.

Therefore, it would be highly desirable to have a new and improved device for surface texture removal which would allow continuous and even application of removing the texture as it is being scraped from the surface of the wall or ceiling.

In addition, a vacuum mechanism is provided for the removal of materials which have been loosened by the action of the surface removal head. The surface removal head could be a mechanical shredder, ultrasonic, sonic, or ultraphonic and is adjustable by means of a plurality of guide rods to treat overhead surfaces. However, the complex surface removal head, worm gear, motorized mechanism and vacuum system are extremely complex. This would require specialized parts, trained technicians for repair and maintenance of the unit and would result in expensive construction and maintenance costs.

Therefore, it would be highly desirable to have a new and improved device for surface texture removal which would be inexpensive to manufacture and which would be inexpensive to maintain.

U.S. Pat. No. 4,765,352 describes a device that addresses the problem of providing a vacuum system to prevent production of aerosols or free dust particles by enclosing the operator within a portable vacuum enclosure which is adjustable to different ceiling heights. However, the device does not provide for any means of even spray distribution for wetting the ceiling surface nor does it provide for a means of scraping the ceiling texture from the surface of ceilings. Presumably, the operator must use mechanical means for spraying a scraping the ceiling surface from the ceiling.

In addition, the unit is very complex and would require specialized parts and trained technicians to repair and maintain the unit which would result in expensive construction and maintenance costs.

Therefore, it would be highly desirable to have a new and improved device for ceiling texture removal which would allow continuous and even application of a liquid, which would provide a means of modifying the device to adapt the scraping mechanism to overhead surfaces, and which would be inexpensive to manufacture and maintain.

U.S. Pat. No. 4,517,700 describes a device that has an adjustable handle attached to a scraping mechanism with attached pad for sandpaper or paint pad which addresses the problem of providing an adjustment mechanism for over-50 head surfaces. However, this inventive apparatus does not provide a means for a vacuum means for removal of surface materials after removal from a ceiling or wall surface.

Therefore, it would be highly desirable to have a new and improved device for surface texture removal which would allow continuous and even application of continuous removal of the texture as it is being scraped from the surface of the wall or ceiling.

### SUMMARY OF THE INVENTION

The present invention provides a new and improved device, for removal of surface texture materials. The inventive device also provides for the safe and effective removal of resultant debris by means of a vacuum mechanism. The debris is then collected and contained within a storage hopper for subsequent disposal.

It is yet a further object of the present invention to provide such a new and improved device, for surface texture removal, which would be inexpensive to manufacture and maintain with few moving parts that would be subject to wear and tear and subsequent frequent replacement.

In a further preferred embodiment of the present invention are realized by providing a new and improved surface texture removal device. More particularly, the present invention relates to a device which enables a renovation professional to apply an even, continuous application of removal of surface texture to facilitate rapid safe removal of said surface texture materials. The resultant debris from the removal of ceiling surface or texture is immediately carried away by use of an integrally attached vacuum system, and delivered to a collection hopper for containment and subsequent disposal. The present device provides for a time saving, labor saving, ergonomic and efficient means by which to remove ceiling surfaces and textures while preventing formation of aerosols or dust particles which might otherwise be inhaled and represent a potential health hazard to the user.

Further objects and advantages of the present invention will become apparent from a description of the several embodiments as set forth in the following description and drawings.

### BRIEF DESCRIPTION OF DRAWINGS

FIG. 1 is a is a top view of the novel surface texture removal device according to the present invention.

FIG. 2 is a rear elevational view of the surface texture removal device according to the present invention.

FIG. 3 is a top elevational view of the novel surface texture removal device with vacuum hose coupler.

### DETAILED DESCRIPTION OF THE INVENTION

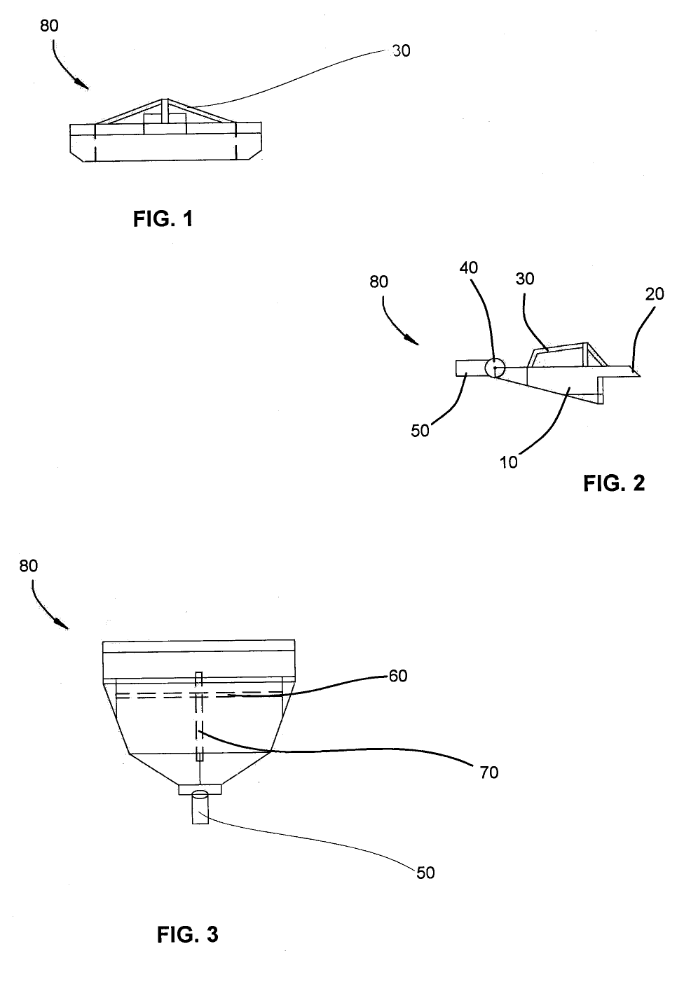

Referring to FIG. 1, there is shown a surface texture removal device 60 which is constructed in accordance with the present invention. The surface texture removal device 60 is used to efficiently, effectively and economically provide removal of texture by providing an adjustable pivot joint mechanism with attached vacuum device for containment and removal of associated debris.

Referring to FIGS. 1-2, a surface texture removal device housing 10 is the primary structural component of the novel surface texture removal device 60. The vacuum hose coupler 50 of the removing device housing 10 forms the base of the surface texture removal device 60. A replaceable catchment tray 20 is attached to the surface texture removal housing 10 by any number of means including but not limited to bolts and nuts, screws, friction fittings, etc.

Referring to FIG. 2, a handle attachment plate 30 is perpendicularly attached to the cross handle support plate 70 at the juncture of the two halves of the cross handle support plate 70. A handle attachment plate 30 is attached by bolt allowing the attachment of any number of handles of different lengths and configurations depending upon the needs of the user.

Referring now to FIG. 3, this top elevational view of the surface texture removal device 60 shows the removing device housing 10 connected to the vacuum hose coupler 50. A replaceable catchment tray 20 is attached to the removing device housing 10. The handle attachment plate 30 is perpendicularly attached to the cross handle support plate 70 at the juncture of the two halves of the cross handle support plate 70.

A vacuum hose coupler 50 attaches to the removing device housing 10 of the surface texture removal device 60 by means of a pivot joint 40. The vacuum hose is attached to the hose vacuum hose coupler 50 by a hose connector piece.

The above mentioned and other objects and features of this invention and the manner of attaining them will become apparent, and the invention itself will be best understood by reference to the following description of the embodiment of the invention in conjunction with the accompanying drawings, wherein:

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. A surface texture removal device with vacuum system comprising:
(a) a tapered chamber having front opening and back opening;
(b) a handle connected to and supporting said chamber;
(c) a collection tray connected to front opening;
(d) a hose coupler connected to said back opening via a pivot joint; and
(e) a vacuum system having a vacuum source, and a vacuum hose connected to said back opening of said chamber, thereby enabling said vacuum system to carry away the removed texture material.

2. The surface texture removal device of claim 1, wherein said tapered chamber is generally funnel shaped.

3. The surface texture removal device of claim 1, wherein said handle includes a cross handle for the purpose of varying the length of said handle.

4. The surface texture removal device of claim 1, wherein said connection means for connecting said handle to said chamber is selected from a group of screws, pivots, or any combination thereof.

5. The surface texture removal device of claim 1, wherein said collection tray is permanently affixed to said chamber.

6. The surface texture removal device of claim 1, wherein said hole coupler is connected to said chamber such that the angle of said hole coupler can be adjusted to conform with the required angle of use of vacuum.

7. The surface texture removal device of claim 1, wherein said hole coupler is permanently affixed to said chamber.

8. The surface texture removal device of claim 1, wherein said vacuum system is mobile.
